(19) United States
(12) Patent Application Publication
(10) Pub. No.: US 2014/0279745 A1
(43) Pub. Date: Sep. 18, 2014

(54) CLASSIFICATION BASED ON PREDICTION OF ACCURACY OF MULTIPLE DATA MODELS

(71) Applicant: Sm4rt Predictive Systems, Cuajimalpa (MX)

(72) Inventors: Carlos F. Esponda, Mexico City (MX); Victor M. Chapela, Mexico City (MX); Liliana Millán, Mexico City (MX); Andrés Silberman, Mexico City (MX)

(73) Assignee: Sm4rt Predictive Systems, Cuajimalpa (MX)

(21) Appl. No.: 14/071,416

(22) Filed: Nov. 4, 2013

Related U.S. Application Data
(60) Provisional application No. 61/785,486, filed on Mar. 14, 2013.

(51) Int. Cl. G06N 7/00

(52) U.S. Cl. CPC G06N 7/005
USPC 706/12

(57) ABSTRACT

A dynamic classifier for performing binary classification of instance data using oracles that predict accuracy of predictions made by corresponding models. An oracle corresponding to a model is trained to generate a confidence value that represents accuracy of a prediction made by the model. Based on the confidence value and predictions, one of multiple models is selected and its prediction is used as an intermediate prediction. The intermediate prediction may be used in conjunction with another prediction generated using a different algorithm to generate a final prediction. By using the confidence value for each model, a more accurate prediction can be made.

### CROSS-REFERENCE TO RELATED APPLICATION

This application claims priority under 35 U.S.C. §119(e) to co-pending U.S. Provisional Patent Application No. 61/785,486, filed on Mar. 14, 2013, which is incorporated by reference herein in its entirety.

### BACKGROUND

1. Field of the Disclosure

The present disclosure relates to a classifier for performing classification of actions or events associated with instance data using multiple models, and more specifically to performing classification of actions or events associate with instance data using multiple classification models.

2. Description of the Related Arts

Predictive analytics allows for the generation of predictive models by identifying patterns in the data sets. Generally, the predictive models establish relationships or correlations between various data fields in the data sets. Using the predictive models, a user can predict the outcome or characteristics of a transaction or event based on available data. For example, predictive models for credit card transactions enables financial institutions to establish the likeliness that a credit card transaction is fraudulent.

Some predictive analytics employ ensemble methods. An ensemble method uses multiple distinct models to obtain better predictive performance than could be obtained from any of the individual models. The ensemble method may involve generating predictions by multiple models, and then processing the predictions to obtain a final prediction. Common types of ensemble method include Bayes optimal classifier, bootstrap aggregating, boosting, and Bayesian model combination, just to name a few.

Such ensemble methods may be used for binary classification. Binary classification refers to the task of classifying an action or event into two categories based on the instance data associated with such action or event. Typical binary classification tasks include, for example, determining whether a financial transaction involves fraud, medical testing to diagnose a patient's disease, and determining whether certain products are defective or not. Based on such classification, various real-world actions may be taken such as blocking the financial transaction, prescribing certain drugs and discarding defective products.

### SUMMARY

Embodiments relate to classifying data by determining confidence values of a plurality of models and selecting a model likely to provide a more accurate model output based on the confidence values. The model outputs are generated by at least a subset of a plurality of models responsive to receiving instance data associated with an action or an event. Each model output represents classification of the action or event made by a corresponding model based on the instance data. The confidence values are generated at oracles based at least on the generated model outputs. Each of the oracles is trained to predict accuracy of a corresponding model. A model likely to provide a more accurate model output is selected based on the model outputs and the confidence values.

In one embodiment, a model output of the selected model is output as a first prediction when the selected model is generating a model output. Conversely, when the selected model is not generating a model output, the identity of the selected model is output.

In one embodiment, a second prediction is generated by processing the model outputs using a mathematical function. A prediction output is generated by processing the first prediction and the second prediction.

In one embodiment, the prediction output is generated by selecting one of the first prediction and the second prediction as the prediction output.

In one embodiment, the prediction output represents a binary classification of the action or event associated with the instance data.

In one embodiment, each of the oracles is trained by receiving training labels of an action or event representing accuracy of a model output of a model relative to model outputs of other models.

In one embodiment, each of the oracles further receive the models outputs of plurality of the models for the actions or events for which a model corresponding to each of the oracles produced the model output more accurate than the model outputs of the other models.

In one embodiment, the confidence values are generated based further on the received instance data.

In one embodiment, the model likely to provide more accurate model output is selected by selecting a first model with a highest model output and a second model with a lowest model output. A first confidence value of the first model and a second confidence value of the second model are compared. Then the first model is selected when the first confidence value is higher than the second confidence value. Conversely, the second model is selected when the first confidence value is not higher than the second confidence value.

In one embodiment, each of the oracles performs a classification tree algorithm to generate a confidence value.

### BRIEF DESCRIPTION OF THE DRAWINGS

The teachings of the embodiments of the present invention can be readily understood by considering the following detailed description in conjunction with the accompanying drawings.

FIG. 1A is a block diagram illustrating a computing device for performing classification operation, according to one embodiment.

FIG. 1B is a block diagram illustrating a dynamic classifier, according to one embodiment.

FIG. 2 is a block diagram illustrating a model selector in the dynamic classifier, according to one embodiment.

FIG. 3 is a flowchart illustrating an overall process of performing classification operation by the dynamic classifier, according to one embodiment.

FIG. 4 is a diagram illustrating a training data entry for training the dynamic classifier, according to one embodiment.

FIG. 5 is a flowchart illustrating a process of training the model selector, according to one embodiment.

FIG. 6 is a conceptual diagram illustrating generating of training labels to train oracles, according to one embodiment.

FIG. 7 is a flowchart illustrating a process of performing inference by a trained dynamic classifier, according to one embodiment.

FIG. 8 is a flowchart illustrating a process of generating a prediction by a model selector, according to one embodiment.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left most digits of each reference number corresponds to the figure in which the reference number is first used.

Embodiments relate to a dynamic classifier for performing classification of an action or event associated with instance data using oracles that predict accuracy of predictions made by corresponding models. An oracle corresponding to a model is trained to generate a confidence value that represents accuracy of a prediction made by the model. Based on the confidence value and predictions, one of multiple models is selected and its prediction is used as an intermediate prediction. The intermediate prediction may be used in conjunction with another intermediate prediction generated using a different algorithm to generate a final prediction. By using the confidence value for each model and for each instance data, a more accurate prediction can be made.

An action or event described herein refers to any real-world occurrence that may be associated with certain underlying data. The action or event may include, for example, a financial transaction, transmission of a message, exhibiting of certain symptoms in patients, and initiating of a loan process.

Instance data described herein refers to any data that is associated with an action or event. The instance data include two or more data fields, some of which may be irrelevant or not associate with the classification of the action or event. The instance data may represent, among others, financial transaction data, communication signals (e.g., emails, text messages and instant messages), network traffic, documents, insurance records, biometric information, parameters for manufacturing process (e.g., semiconductor fabrication parameters), medical diagnostic data, stock market data, historical variations in stocks, and product rating/recommendations.

A prediction described herein refers to determining of values or characteristics of an action or event based on analysis of the instance data associated with the action or event. The prediction is not necessarily associated with a future time, and represents determining a likely result based on incomplete or indeterminate information about the action or event. The prediction may include, but not limited to, determining of fraud in financial transaction, classification of digital images as pornographic or non-pornographic, identification of email messages as unsolicited bulk email (‘spam’) or legitimate email (‘non-spam’), identification of network traffic as malicious or benign, and identification of anomalous patterns in insurance records. The prediction also includes non-binary predications such as contents (e.g., book and movie) recommendations, identification of various risk levels and determination of type of fraudulent transaction.

Embodiments are described herein primarily with respect to binary classification where a prediction indicates categorization of an event or action associated with instance data to one of two categories. For example, a prediction based on a credit card transaction indicates whether the transaction is legitimate or fraudulent. However, the principle of algorithms as described herein may be used in predictions other than binary classification.

### Example Architecture of Computing Device

FIG. 1A is a block diagram illustrating computing device 100 for performing classification operation, according to one embodiment. The computing device 100 may include, among other components, processor 102, input module 104, output module 106, memory 110 and bus 103 connecting these components. The computing device 100 may include components such as a networking module not illustrated in FIG. 1A.

Processor 102 reads and executes instructions stored in memory 110. Although a single processor 102 is illustrate in FIG. 1A, two or more processors may be provided in computing device 100 for increased computation speed and capacity.

Input module 104 is hardware, software, firmware or a combination thereof for receiving data from external sources. Input module 104 may provide interfacing capabilities to receive data from an external source (e.g., storage device). The data received via input module 104 may include training data for training dynamic classifier 114 and instance data associated with events or actions to be classified by dynamic classifier 114. Further, the data received via input module 104 may include various parameters and configuration data associated with the operation of dynamic classifier 114.

Output module 106 is hardware, software, firmware or a combination thereof for sending data processed by computing device 100. Output module 106 may provide interfacing capabilities to send data to external sources (e.g., storage device). The data sent by computing device 100 may include, for example, final predictions generated by dynamic classifier 114 or other information based on the final predictions. Output module 106 may provide interfacing capabilities to external device such as storage devices.

Memory 110 is a non-transitory computer-readable storage medium capable of storing data and instructions. Memory 110 may be embodied using various technology including, but not limited to, read-only memory (ROM), random-access memory (RAM), flash memory, network storage and hard disk. Although memory 110 is illustrated in FIG. 1A as being a single module, memory 110 may consist of more than one module operating using different technology.

Although FIG. 1A illustrates a single computing device implementing dynamic classifier 114, in other embodiments, a distributed computing scheme may be employed to implement dynamic classifier 114 across multiple computing devices.

### Example Architecture of Dynamic Classifier

FIG. 1B is a block diagram illustrating dynamic classifier 114, according to one embodiment. Dynamic classifier 114 is trained using training data received as input data 120 during a training phase. In an inference phase subsequent to the training phase, dynamic classifier 114 receives instance data as input data 120 and performs classification operation (e.g., binary classification) based on the training. Input data 120 may be received via input module 104 from one or more external sources.

In one embodiment, the dynamic classifier 114 is comprised of three levels. The first level includes multiple data models M1 through Mn (hereinafter collectively referred to as “data models M”). Data models M receive input data 120 and generates model outputs MO1 through MOn (hereinafter collectively referred to as “model outputs MO”). Each of the model outputs MO represents a prediction made by each of the data models MO1 through MOn based on input data 120. Each of data models M1 through Mn may use a different prediction or classification algorithm or operate under different operating parameters to generate model outputs MO1 through MOn of different accuracy. Example prediction or classification algorithms for embodying the data models include, among others, Hierarchical Temporal Memory (HTM) algorithm available from Numenta, Inc. of Redwood City, Calif., support vector machines (SVM), decision trees, random forests, and neural networks. In one embodiment, all of the model outputs MO1 through MOn are normalized to be within a certain range so that the model outputs MO1 through MOn may be compared. For example, all the model outputs MO1 through MOn may take a value between 0 and 1.

The second level of the dynamic classifier 114 receives and processes a subset of the model outputs MO along with instance data to generate one or more intermediate predictions using two or more modules using different algorithms. In the embodiment of FIG. 1B, the second level includes two modules: integrator 128 and model selector 132. Model selector 132 and integrator 128 generate first intermediate prediction 133 and second intermediate prediction 129, respectively.

Integrator 128 processes model outputs MO1 through MOn to generate second intermediate prediction 129. Various algorithms may be employed by the integrator 128 to process model outputs MO1 through MOn into second intermediate prediction 129. In its simplest embodiment, integrator 128 may use mathematical functions such as a median function to compute a median value of model outputs MO1 through MOn as second intermediate prediction 129 or an average function to compute an average value of the model outputs MO1 through MOn to generate second intermediate prediction 129. In other embodiments, integrator 128 may use machine learning algorithms such as regularized logistic regression, support vector machines (SVM), and random forests. In such embodiments, integrator 128 may itself form a data model of a second level that can be trained using model outputs MO and training data. The training data provided to the integrator 128 may be the same training data provided to the data models, a sequence or time shifted version of the same training data (i.e., the training data is advanced or delayed by a predetermined number of training data entries or time) or a completely different version training data.

Contrary to integrator 128 that processes model outputs MO to compute second intermediate prediction 129 as a function of all model outputs MO, model selector 132 may select one of the data models M1 through Mn and use the model output of the selected data model as first intermediate prediction 133. For the purpose of selecting the models M, the model selector 132 includes a number of oracles corresponding to the number of models to provide confidence values for each model, as described below in detail with reference to FIG. 2.

Although the second level of the dynamic classifier 114 is illustrated in FIG. 1B as having only one integrator and one model selector, more than one integrator and one model selector may be provided in the second level. Each of the integrators and the model selectors may receive a different subset of model outputs MO or operate using different parameters so that each of the integrators and the model selectors may produce different intermediate predictions based on the same instance data.

The third level of the dynamic classifier 114 includes an output generator 136 that generates final prediction 152 based on intermediate predictions 129, 133 received from modules in the second level. In one embodiment, the output generator 136 operates in substantially the same way as the model selector 132 except that the output generator 136 receives intermediate predictions 129, 133 as input. Output generator 136 may be trained using intermediate predictions 129, 133 and input data 120 to form a data model for determining under which circumstances one of two intermediate predictions 129, 133 are more accurate. In other embodiments, the output generator 136 may use other machine learning algorithms or mathematical function to generate final prediction 152. Final prediction 152 may be sent out from computing device 100 via output module 106 to an external device.

FIG. 2 is a block diagram illustrating model selector 132 in the dynamic classifier 114, according to one embodiment. Model selector 132 is trained during the training phase to detect which one of the data models M1 through Mn is likely to produce the most accurate prediction. Specifically, model selector 132 includes oracles O1 through On. Each oracle is associated with a corresponding data model to learn when the corresponding data model produces accurate predictions. Specifically, during a training phase, each of the oracles receives training data entries and models outputs MO1 through MOn, and training labels representing relative accuracy (or inaccuracy) of a model relative to other models, as described below in detail with reference to FIG. 5.

In an inference phase subsequent to the learning phase, each of oracles receives instance data (as part of input data 120) and a subset of the model outputs MO. Oracles O1 through On generate and output confidence values 222 representing the likelihood that a corresponding data model M is producing an accurate prediction.

Various algorithms may be used to embody the oracles. In one embodiment, C4.5 or C5.0 classification tree algorithm as described in, for example, J. Ross Quinlan, “Programs for Machine Learning,” Morgan Kaufmann Publishers (1993); and J. Ross Quinlan, “Induction of Decision Trees,” Machine Learning 1:81-106 (March, 1986), which are incorporated by reference herein in its entirety, may be used to embody the oracles. In such case, class probabilities of these algorithms may be used as the confidence values 222 of the oracles. Some of many advantages of using such classification tree algorithm are that these algorithms are non-parametric, can use various types of data as input, and are relatively fast. In other embodiments, algorithms such as random forest and support vector machines (SVM) may be used to embody the oracles.

Output selector 210 generates first intermediate prediction 133 based on the confidence values 222 and model outputs MO1 through MOn. One way of generating first intermediate prediction 133 at output selector 210 is to use a Min-Max function to select the highest model output and the lowest model output, and then compare the confidence values generated by the oracles corresponding to the two selected models, as described below in detail with reference to FIG. 8. The use of the Min-Max function is especially advantageous in binary classification tasks. Output selector 210 then outputs the model output associated with a higher confidence value to output generator 136 as first intermediate prediction 133. In non-binary classification, the output selector 210 may simply choose a model output of a model predicted by oracles to be the most accurate as first intermediate prediction 133 without using the Min-Max function. In some embodiments, the output selector 210 may generate a default value as first intermediate prediction 133 if the confidence values of the all oracles are below a certain level.

### Example Method of Producing Prediction

FIG. 3 is a flowchart illustrating an overall process of performing a classification operation, according to one embodiment. First, dynamic classifier 114 is trained 310 using training data as input data 120 during a training phase. During the training phase, components of the dynamic classifier 114 such as models M1 through Mn, integrator 128, model selector 132, and output generator 136 are trained to produce more accurate final prediction 152. The process of training model selector 132 is described below in detail with reference to FIGS. 5 and 6.

After training its components, dynamic classifier 114 performs 320 inference using instance data as input data 120 in an inference phase, as described below in detail with reference to FIG. 7.

FIG. 4 is a diagram illustrating a training data entry for training dynamic classifier 114, according to one embodiment. Training data may include a plurality of training data entries, each representing a different action or event. Each training data entry 400 may include instance data 402 and a correct label (CL). The instance data 402 include multiple data fields I1 through Iz associated with the action or event and relevant to the classification operation. Different models M1 through Mn may assign different weight to each data fields in producing their model outputs MO1 through MOn. The correct label indicates the correct classification of the action or event associated with the instance data 402 and is used to train models M1 through Mn to produce more accurate predictions. The correct label is also used to train the oracles O1 through On to more accurately identify circumstances under which models M1 through Mn are likely to produce accurate model outputs. The correct label may be assigned by collecting the instance data 402 in advance and confirming which of the two binary categories that the event or action associated with the instance data 402 should belong to. During the inference stage, instance data 402 without the correct label is provided as input data 120 to dynamic classifier 114 to classify an event or action associated with instance data 402.

The data fields I1 through Iz may represent different data depending on the application of dynamic classifier 114. For example, when dynamic classifier 114 is used for detecting fraud in credit card transactions, the data fields I1 through Iz may indicate one or more of the following: (i) the amount of credit card transaction, (ii) the location of the transaction, (iii) the time of the transaction, (iv) the category of merchant associated with the transaction, (v) credit limit of the credit card, (vi) the length of time the credit card has been used. (vii) day or week or month, (viii) transaction history (e.g., previous merchants and past transaction amounts). In an example where dynamic classifier 114 is used for determining whether an email is a spam or not, the data fields I1 through Iz may indicate one or more of the following: (i) recipient's IP address, (ii) sender's IP address, (iii) time that the email was transmitted, (iv) geographical location where the email originated, (v) the size of the email, (vi) whether the email includes file attachments, and (vii) and inclusion of certain strings of characters.

FIG. 5 is a flowchart illustrating a process of training model selector 132, according to one embodiment. It is assumed that models M1 through Mn are already trained using the same or different training data so that models M1 through Mn can generate model outputs MO1 through MOn for the sake of explanation.

First, the model selector 132 receives 504 training data entry including instance data and a correct label. The model selector 132 also receives 510 model outputs MO from models M1 through Mn. Referring to FIG. 6, an example of model outputs MO1 through M04 generated from four different models using six training data entry is illustrated. The correct label in this example takes the value of either 0 or 1. The instance data of the first training data entry has field values of I01 through I0z. In response to receiving the instance data of the first training data entry, each of models M1 through M4 generates model outputs of 0.3, 0.2, 0.8 and 0.9, respectively. The correct label for the first training entry is “0,” and hence, model M2 generated a model output value of 0.2 which is closest to this correct label “0”. Hence, model M2 is flagged by updating training label B2 to “1” while updating other training labels to “0” to indicate that model M2 is the most accurate model for the instance data of the first training data entry.

Referring back to FIG. 5, after flagging the model for the training data entry, it is determined 516 if the previous training data entry is the last training data entry. If not, the process returns to receiving 504 the next training data entry and repeats the subsequent processes.

In the example of FIG. 6, the instance data of the second training data entry has field values of I11 through I1z, the instance data of the second training data entry has field values of I11 through I1z. In response to receiving the instance data of the second training data entry, each of models M1 through M4 generates model outputs of 0.6, 0.7, 0.5 and 0.4, respectively. The correct label for the first training entry is “1,” and hence, model M2 generated a model output value of 0.7 which is closest to this correct label “1”. Hence, model M2 is again flagged by updating training label B2 to “1” while updating other training labels to “0” to indicate that model M2 is the most accurate model for the instance data of the second training data entry. In a similar manner, model M1 is flagged as the most accurate model by updating training label B1 to “1” while updating other training labels to “0” to indicate that model M1 is the most accurate model for the instance data of the third and fourth training data entries; and model M3 and model M4 are flagged as the most accurate model for the fifth and sixth training data entries. If there are ties in the accuracy of the models, then more than one training labels B1 through B4 for the training data entry may be designated as “1”.

Referring back to FIG. 5, the processes of receiving 504 the training data entry through flagging 512 a model for the training data entry are repeated until it is determined 516 that the previous training data entry is the last training entry.

After repeating receiving 504 of the training data entry through flagging 512 for all the training data entries, the process proceeds to cause 520 each oracle corresponding to each model to learn patterns in model outputs and/or training data entries based on whether a model was flagged as the most accurate model or not. Taking the example of FIG. 6, instance data and/or the model outputs of the first and second training data entry along with the training labels B1 through B4 are fed to oracles. By feeding the instance data and/or the model outputs of the first and second training data entry along with the training labels B1 through B4, oracles learn patterns in instance data and/or the model outputs associated with labels B1 through B4 representing which of the models were most accurate. After training the oracles, the training of model selector 132 terminates.

Various modifications may be made to the process illustrated with reference to FIG. 5. For example, instead of using the models that are already trained, the models may learn to generate model outputs as the training entries are provided to the model selector 132 and the models.

FIG. 7 is a flowchart illustrating a process of performing inference by a trained dynamic classifier 114, according to one embodiment. At least a subset of model outputs MO1 through MOn is generated 710 at models M1 through Mn based on instance data received at dynamic classifier 114. In some embodiment, some of the model outputs MO1 through MOn may be absent. Each of the generated model outputs MO1 through MOn may be normalized to be within a certain predetermined range (e.g., between 0 and 1). Producing a model output that is closer to one extreme of the range at data model indicates that the data model is more confident that the instance data should be classified to a category corresponding to the extreme range. For example, a model output closer to a value of 1 indicates that a credit card transaction represented by a corresponding instance data is more likely to be associated with fraud while a model output closer to a value of 0 indicates that the credit card transaction is more likely to be legitimate.

Model selector 132 of dynamic classifier 114 receives the model outputs MO1 through MOn and/or instance data, and generates 720 first intermediate prediction 133 using a first algorithm, as described below in detail with reference to FIG. 8.

Integrator 128 of dynamic classifier 114 receives the model outputs MO1 through MOn and/or instance data, and generates 730 second intermediate prediction 129 using a second algorithm different from the first algorithm. As described above in detail with reference to FIG. 1B, various functions or learning algorithms may be used as the second algorithm for operating integrator 128.

Output generator 136 receives first and second intermediate predictions 129, 133 and/or instance data, and generates final prediction 152, as described above in detail with reference to FIG. 1B.

Various modification may be made to the process illustrate with reference to FIG. 7. For example, although the process in FIG. 7 is illustrated as generating first intermediate prediction 133 before generating second intermediate prediction 129, second intermediate prediction 129 may be generated before first intermediate prediction 133 or both intermediate predictions 129, 133 may be generated in parallel. Also, further processing may be performed on the first and second intermediate predictions 129, 133 before being fed to output generator 136 to generate final prediction 152. In other embodiments, more than two intermediate predictions may be generated by one or more additional modules in the second level of dynamic classifier 114 to generate final prediction 152.

FIG. 8 is a flowchart illustrating a process of generating first intermediate prediction 133 by model selector 132, according to one embodiment. Model selector 132 receives 804 instance data for inference. Model selector 132 also receives 808 at least a subset of model output MO1 through MOn and instance data for processing.

Output selector 210 of model selector 132 selects 812 a first model generating the highest model output and a second model generating the lowest model output based on model outputs MO1 through MOn and/or received instance data. In some embodiments, if the confidence values of the oracles are below a certain level, a default value may be output from the output selector 210.

A first confidence value and a second confidence value are generated 816 from a first oracle and a second oracle, respectively. The first oracle corresponds to the first model, and the second oracle corresponds to the second model.

A final model is then selected 820 from the first and second models based on the first and second confidence values. Specifically, one of the first and second models having their corresponding oracles produce a higher confidence is selected as the final model.

The model output of the final model is then sent 824 out as first intermediate prediction 133 from model selector 132.

The process of generating first intermediate prediction described with reference to FIG. 8 is merely illustrative. Various modifications may be made to the processes. For example, the instance data may be received 804 after receiving 808 model outputs MO from the models or the instance data and the model outputs may be received at the same time.

Also, instead of generating the confidence values for only the first and second models, the confidence values for all models may be computed. Then, a model with the highest confidence value may be selected as the final model.

Further, instead of selecting only one first model and one second model, two or more models with the highest model outputs and two or more models with the lowest model outputs may be selected. Then, the model having a corresponding oracle produce the highest confidence value may be selected as the final model.

### Alternative Embodiments

Although above embodiments are primarily described for binary classification, other embodiments may be used for other types of non-binary classification. For this purpose, more than one dynamic classifier may be used in conjunction to classify instance data into more than two categories. The oracles may also be trained using training labels that indicate are assigned a certain value (e.g., “1”) if the model outputs have a deviance from the correct label less than a threshold. Output generator 136 may also be modified to perform multiple category classification based on one or more of intermediate prediction 133, second intermediate prediction 129 and input data 120.

Also, instead of providing only three levels as described with reference to FIG. 1B, more than three levels may be provided to derive more accurate prediction from the highest level. In the second or higher levels, more than one integrator or model selector may be provided to training and produce predictions.

In some embodiments, one or more of the model outputs MO may be absent at the time of inference. That is, only a subset of the models M1 through Mn generates model output MO1 through MOn. For example, when certain fields of input data 120 available during a training phase may not be available during an inference phase. In such cases, one or more of the models M1 through Mn may not generate model outputs during an inference phase due to lack of such data fields. When one or more of the models M1 through Mn are not generating any model outputs, the model selector 132 can still use available model outputs MO and/or instance data to predict which model is likely to be the most accurate. The model selector 132 may then simply notify the identity of the selected model to the user or data provider of the instance data for further inquiry. In response to receiving the identity of the selected model, the user or the data provider may perform further actions to provide information or flag the corresponding instance data for further analysis.

Upon reading this disclosure, those of skill in the art will appreciate still additional alternative designs for dynamic classifier. Thus, while particular embodiments and applications have been illustrated and described, it is to be understood that embodiments are not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A computer-implemented method of classifying data, comprising:
generating model outputs by at least a subset of a plurality of models responsive to receiving instance data associate with an action or an event, each generated model output representing classification of the action or the event made by a corresponding model based on the instance data;
generating confidence values of the models for the instance data at oracles based at least on the generated model outputs, each of the oracles trained to predict accuracy of a corresponding model for the instance data; and
selecting a model likely to provide a more accurate model output based on the model outputs and the confidence values for the instance data.

2. The method of claim 1, further comprising:
outputting a model output of the selected model as a first prediction on the action or the event responsive to the selected model generating a model output; and
outputting an identity of the selected model responsive to the selected model not generating a model output.

3. The method claim 1, further comprising:
generating a second prediction by processing the model outputs using a mathematical function, and
generating a prediction output by processing the first prediction and the second prediction.

4. The method of claim 3, wherein generating the prediction output comprises selecting one of the first prediction and the second prediction as the prediction output.

5. The method of claim 3, wherein the prediction output represents a binary classification of the action or event associated with the instance data.

6. The method of claim 1, wherein each of the oracles are trained by receiving training labels of an action or event representing accuracy of a model output of a model relative to model outputs of other models.

7. The method of claim 6, wherein each of the oracles further receives the models outputs of plurality of the models of the action or the event for which the model corresponding to each of the oracles produced the model output more accurate than the model outputs of the other models.

8. The method of claim 1, wherein the confidence values are generated based further on the received instance data.

9. The method of claim 1, wherein selecting the model likely to provide more accurate model output comprises:
selecting a first model with a highest model output and a second model with a lowest model output;
comparing a first confidence value of the first model and a second confidence value of the second model;
selecting the first model responsive to the first confidence value being higher than the second confidence value; and
selecting the second model responsive to the first confidence value being not higher than the second confidence value.

10. The method of claim 1, wherein each of the oracles performs a classification tree algorithm to generate a confidence value.

11. The method of claim 1, wherein the instance data represents transaction data for credit cards, and the model outputs indicate predictions made by the models on whether a credit card transaction is fraudulent.

12. A computing device, comprising:
a processor;
a plurality of models, at least a subset of the plurality of models configured to generate model outputs responsive to receiving instance data associated with an action or an event, each generated model output representing classification of the action or the event made by each model;
a plurality of oracles configured to generating confidence values of corresponding models based at least on the generated model outputs, each of the oracles trained to predict accuracy of a corresponding model for the instance data;
an output selector configured to select one of the plurality of models likely to provide an accurate model output based on the model outputs and the confidence values for the instance data.

13. The computing device of claim 12, wherein the output selector is further configured to:
output a model output of the selected model as a first prediction on the action or the event responsive to the selected model generating a model output; and
output an identity of the selected model responsive to the selected model not generating a model output.

14. The computing device of claim 12, further comprising:
an integrator configured to generate a second prediction by processing the model outputs using a mathematical function, and
an output generator configured to generate a prediction output by processing the first prediction and the second prediction.

15. The computing device of claim 14, wherein the prediction output is generated by selecting one of the first prediction and the second prediction as the prediction output.

16. The computing device of claim 14, wherein the prediction output represents a binary classification of the action or event associated with the instance data.

17. The computing device of claim 12, wherein each of the oracles are trained by selectively receiving training labels of an action or event representing accuracy of a model output of a model relative to model outputs of other models.

18. The computing device of claim 17, wherein each of the oracles further receives the models outputs of plurality of the models of the action or the event for which the model corresponding to each of the oracles produced the model output more accurate than the model outputs of the other models.

19. The computing device of claim 12, wherein the output selector is configured to:
select a first model with a highest model output and a second model with a lowest model output;
compare a first confidence value for the first model and a second confidence value for the second model;
select the first model responsive to the first confidence value being higher than the second confidence value; and
select the second model responsive to the first confidence value being not higher than the second confidence value.

20. A non-transitory computer-readable storage medium configured to store instructions, when executed by a processor, cause the processor to:
generate model outputs by at least a subset of a plurality of models responsive to receiving instance data associate with an action or an event, each generated model output representing classification of the action or the event made by a corresponding model based on the instance data;
generate confidence values of the models for the instance data at oracles based at least on the generated model outputs, each of the oracles trained to predict accuracy of a corresponding model for the instance data; and
select a model likely to provide a more accurate model output based on the model outputs and the confidence values for the instance data.
